(19) United States
(12) Patent Application Publication
(10) Pub. No.: US 2016/0147880 A1
(43) Pub. Date: May 26, 2016

(54) MULTI-DIMENSIONAL VISUALIZATION OF QUERY EXECUTION IN DISTRIBUTED DATABASES

(71) Applicants: Daniel Scheibli, Karlsruhe (DE); Christian Dinse, Karlsruhe (DE)

(72) Inventors: Daniel Scheibli, Karlsruhe (DE); Christian Dinse, Karlsruhe (DE)

(21) Appl. No.: 14/553,297

(22) Filed: Nov. 25, 2014

(51) Int. Cl. G06F 17/30

(52) U.S. Cl. CPC G06F 17/30864; G06F 17/30545; G06F 17/30867

(57) ABSTRACT

The present disclosure describes methods, systems, and computer program products providing multi-dimensional visualization of a query executing in a distributed database according to an implementation. Log data for an executing query is received from each database server forming a distributed database system. The received log data is processed to generate a multi-dimensional visualization of the database query execution, the multi-dimensional visualization transmitted to display on a client device and including representing: 1) each database server as a point on a circular structure, 2) a progression of time with respect to each point as a line projecting perpendicularly from the circular structure and connecting to another circular structure with time the same at a particular corresponding point on each line, 3) data traffic as inwardly-pointing data traffic lines connecting the lines, and 4) information about database query execution in an outwardly direction from the lines representing the database.

### BACKGROUND

Even using high-performance databases with short query response times (e.g., an in-memory database), sometimes a single database server is not capable of performing to an expected level. One approach for faster/more-efficient database processing is to partition data and distribute a database among multiple connected and distributed servers for concurrent processing. For example if a single query needs to process one-hundred-million records, ten servers coordinated servers could each be allocated ten-million records for processing in order generate the result of the query. Current visualization techniques for a complex query's execution are often cluttered, unclear, and difficult to extract meaningful data from. As a result, inefficiencies in the execution of a distributed database system (e.g., interaction between different database servers) are often not addressed in a timely and/or optimum manner resulting in lost resources (e.g., revenue, overhead costs, and other resources.), database inefficiencies, and/or non-optimum performance adjustments to optimize the operation of the distributed database system.

### SUMMARY

The present disclosure relates to computer-implemented methods, computer-readable media, and computer systems providing multi-dimensional visualization of a query executing in a distributed database according to an implementation.

Log data for an executing query is received from each database server forming a distributed database system. The received log data is processed to generate a multi-dimensional visualization of the database query execution, the multi-dimensional visualization transmitted to display on a client device and including representing: 1) each database server as a point on a circular structure, 2) a progression of time with respect to each point as a line projecting perpendicularly from the circular structure and connecting to another circular structure with time the same at a particular corresponding point on each line, 3) data traffic as inwardly-pointing data traffic lines connecting the lines, and 4) information about database query execution in an outwardly direction from the lines representing the database.

One computer-implemented method includes receiving log data from each of a plurality of database servers forming a distributed database system executing a database query; processing, by a computer, the received log data to generate a multi-dimensional visualization of the database query execution in the distributed database, wherein the multi-dimensional visualization includes: representing each of the plurality of database servers as a point on a circular structure, each point equidistant from each other on the circular structure; representing a progression of time with respect to each point as a line corresponding to each database server, wherein the line projects perpendicularly from the circular structure and connects to another circular structure parallel to the circular structure, and wherein time is the same at a particular corresponding point on each line; representing data traffic between database servers as inwardly-pointing data traffic lines connecting the lines corresponding to the database servers; and representing information about database query execution with respect to each database server in an outwardly direction from the lines representing the database servers; and transmitting the multi-dimensional visualization to a client device for display.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein the circular structure represents a starting time and the another circular structure indicates a stop time.

A second aspect, combinable with any of the previous aspects, wherein the inwardly-pointing data traffic lines include an arrow or gradient indicating a data traffic flow direction.

A third aspect, combinable with any of the previous aspects, wherein the latest finish time for the inwardly-pointing data traffic lines determines the overall end time for the database query execution.

A fourth aspect, combinable with any of the previous aspects, wherein the inwardly-pointing data traffic lines are drawn perpendicularly from a first database server to a second database server and indicate a start time of a transfer at both the first database server and the second database server.

A fifth aspect, combinable with any of the previous aspects, wherein the inwardly-pointing data traffic lines are drawn diagonally from a first database server to a second database server and indicate a start time of a transfer at the first database server and a stop time of the transfer at the second database server.

A sixth aspect, combinable with any of the previous aspects, wherein the inwardly-pointing data traffic lines are drawn to represent an area spanning from a first database server to a second database server that indicates a start time to an end time of a transfer, respectively.

The subject matter described in this specification can be implemented in particular implementations so as to realize one or more of the following advantages. First, current query execution process visualization techniques typically focus on parts of available information—for instance, visualizations that show activity on one database server/node as a two-dimensional stair-step line chart or GANTT chart (e.g., in CPU utilization screens). It is difficult to show multiple types of data for even a single server on a single chart with proper context (e.g., time, activity level, maximum and minimum values, and the like). Adding other dimensions (e.g., a third or higher dimension) allows for additional data points to be represented in a meaningful/digestible way (e.g., It is not only about what is running and when, but also where and about how the interaction between servers is performing). Second, for distributed landscapes available information is often aggregated into a single chart or alternatively drawn as a sequence of charts (e.g., one per server). This exacerbates the first issue above. In these aggregated charts, data transfers cannot be included nicely because data from the multiple servers can overlap (e.g., server A sends to server D and at the same time sends to servers B and C). In a two-dimensional chart, this overlap can hide useful information and make finding it difficult. Adding an additional dimension allows data to be separated in a more meaningful way as well as separated in visualized “space.” Third, the additional dimension allows for enhanced visualization abilities (e.g., zoom, pan, focus, filtering, and the like). Fourth, a status snapshot of one or more servers can be taken using a data snapshot tool that leverages available multiple dimensions to choose a visualized point-in-time in which to take a status snapshot. Fifth, visualized database operations are of a finer grain and closely track server CPU utilization without having to measure actual CPU utilization (which is computationally expensive). For example, compared to GANTT charts, visualizations displayed using the enhanced visualization abilities and using additional dimensions (e.g., displayed curves/areas on displayed “sun ray” graph structures (see below) are easier to consume, because they show everything in one chart (i.e., it “scales well” because it works for a plan with one operator as well as for plans with multiple operator. A GANTT chart does not, because it produces a longer chart requiring scrolling to see all the data. Also, if a “number of active operators” and a “CPU utilization” line is drawn, then both lines match pretty well. This is to be expected, because, in some implementations, every active operator can utilize one CPU and the CPU utilization also tracks the CPUs in use. Since active operator information in already in available database log files, CPU utilization information is not necessary to collect (which would be relatively expensive to collect for the same granularity level that the logs provide). Sixth, the combination of activity charts per distributed database servers and data transfers between the servers can also be used in other domains (e.g., manufacturing with cases where produced goods travel between machines, or trading on and between different stock exchanges). Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a high-level architecture block diagram illustrating an example distributed computing system (EDCS) providing multi-dimensional visualization of a query executing in a distributed database according to an implementation.

FIG. 2 is an example illustration of a typical two-dimensional data chart displaying query execution data associated with the EDCS according to an implementation.

FIG. 3A is an example illustration of a multi-dimensional visualization of query execution in a distributed database of the EDCS according to an implementation.

FIG. 3B is an example illustration of a multi-dimensional visualization of query execution in a distributed database of the EDCS with an active data snapshot tool according to an implementation.

FIG. 3C is an example illustration of the multi-dimensional visualization of FIG. 3A without an active data snapshot tool according to an implementation.

FIG. 3D is an example illustration of a multi-dimensional visualization of FIG. 3C with alternative data traffic indication lines according to an implementation.

FIG. 4 is a flow chart of a method for providing multi-dimensional visualization of query execution in distributed databases according to an implementation.

FIG. 5 is a block diagram of an exemplary computer used in the EDCS according to an implementation.

Like reference numbers and designations in the various drawings indicate like elements.

### DETAILED DESCRIPTION

The following detailed description is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

Even using high-performance databases with short query response times (e.g., an in-memory database), sometimes a single database server is not capable of performing to an expected level. One approach for faster/more-efficient database processing is to partition data and distribute a database among multiple connected and distributed servers for concurrent processing. For example if a single query needs to process one-hundred-million records, ten servers coordinated servers could each be allocated ten-million records for processing in order generate the result of the query. Current visualization techniques for a complex query's execution are often cluttered, unclear, and difficult to extract meaningful data from. As a result, inefficiencies in the execution of a distributed database system (e.g., interaction between different database servers) are often not addressed in a timely and/or optimum manner resulting in lost resources (e.g., revenue, overhead costs, and other resources.), database inefficiencies, and/or non-optimum performance adjustments to optimize the operation of the distributed database system.

Current query execution process visualization techniques typically focus on parts of available information. For instance, visualizations that show activity on one database server/node as a two-dimensional stair-step line chart or GNATT chart (e.g., in CPU utilization screens). It is difficult to show multiple types of data for even a single server on a single chart with proper context (e.g., time, activity level, maximum and minimum values, and the like) as the data overlaps and is hidden. Adding other dimensions (i.e., a third or higher dimension) allows for additional data points to be represented in a meaningful/digestible way (e.g., It is not only about what is running and when, but also where and about how the interaction between servers is performing). For distributed database landscapes available information is often aggregated into a single chart or alternatively drawn as a sequence of charts (e.g., one per server). This exacerbates the preceding. In these aggregated charts, data transfers cannot be included nicely because data from the multiple servers can overlap (e.g., server A sends to server D and at the same time sends to servers B and C). In a two-dimensional chart, this overlap can hide useful information and make finding it difficult. Adding the third dimension allows data to be separated in a more meaningful way as well as separated in space per server. The additional dimension also allows for enhanced visualization abilities (e.g., zoom, pan, focus, filtering, and the like). The provided visualization perspective also allows a status snapshot of one or more servers to be taken using a visualization tool leveraging the available multiple dimensions to quickly choose a point-in-time in which to take a snapshot. Database operations can also be visualized at a finer grain and closely tracking server CPU utilization without having to measure actual CPU utilization (which is computationally expensive) as logs are mined and data visualized.

The detailed description describes providing a three-dimensional (3D) visualization that integrates different data aspects for a distributed database server/node. Data for existing two-dimensional (2D) diagram types are combined into the 3D view. For example, in some implementations:
1. A circle is used as a basic form but in other implementations, other shapes can be used (e.g., a quadrilateral, triangle, other shape, etc.). On a circular implementation, database servers as part of a distributed database system are we represented/drawn as equally spaced points (e.g., if the distributed database system has six servers 1-6, then the servers 1-6 can be placed equidistant from each other at 12, 2, 4, 6, 8, and 10 o'clock on the circle, respectively.
2. Lines are used to represent data traffic between the points (servers) on the circle.
3. A higher dimension (e.g., the third) is used to represent time. As a result, the circle becomes a cylinder. One end of the cylinder (e.g., the left) represents the start of a query; the other end of the cylinder represents the successful completion of the query.
4. Data traffic between servers (symbolized by the lines) is drawn at an appropriate place within the cylinder connecting a line to another line. Note that multiple options are available such as: (i) drawing a perpendicular arrow from a server A to server B (i.e., a start time of a transfer to start time of transfer), (ii) drawing a diagonal arrow from server A to server B (i.e., start time of transfer to end time of transfer) or (iii) drawing an area spanning server A to server B and start time of transfer to end time of the transfer.
5. The outer side of the cylinder is extended outward with information about the activity (e.g., the number of operations that are active at any given time during the query execution) on a particular server (e.g., this can be represented using a regular line chart positioned with its base as line representing the server through time). For instance, looking along the axis of the “cylinder”, the result would resemble a sun with round body and sun “rays” (server activity) extending outward from it. Looking from the side, the activity of a particular node(s) is shown.

Note that the preceding implementation is only one of a number of possible implementations using multiple dimensions to represent data related to query execution on a distributed database system and is not meant to limit the disclosure in any way. For example, a fourth dimension might be used to represent multiple instances of the above-describe cylinders of different timeframes. In addition, multiple distributed database systems could be represented on a single “chart” with data connections between the above-described cylinders representing intra-distributed-database-system data traffic. Those of ordinary skill will recognize, based on this disclosure, that the described (and other) data may be displayed in manners varying from the explicit description of the disclosure, but that these variations are still within the scope and spirit of this description. The possible alternate implementations are intended to be within the scope of this disclosure.

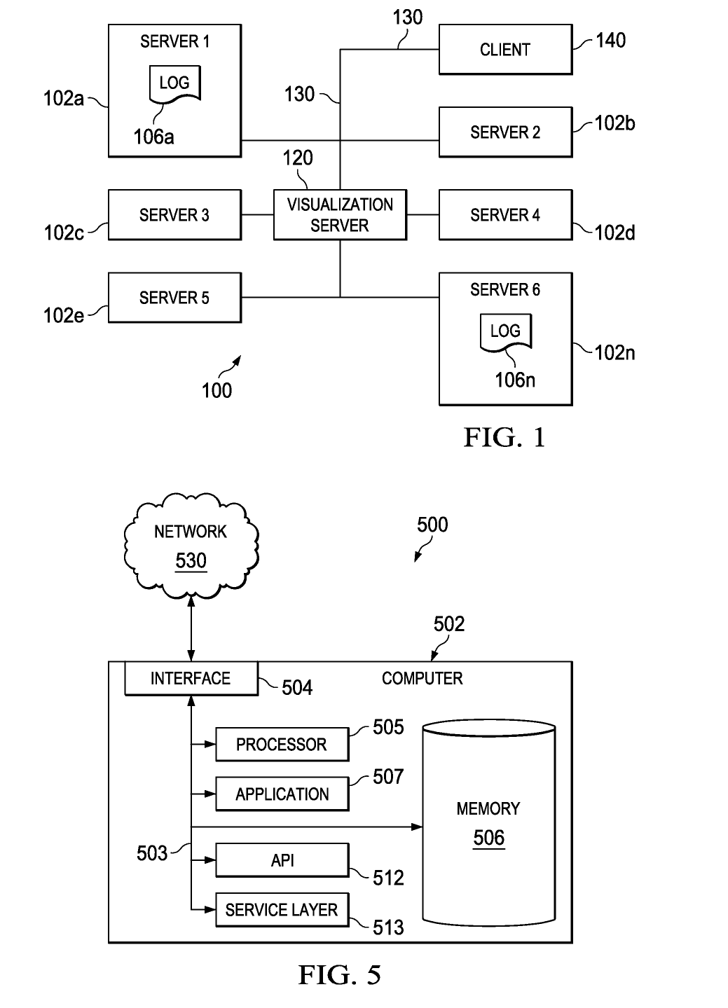

FIG. 1 is a high-level architecture block diagram illustrating an example distributed computing system (EDCS) 100 providing multi-dimensional visualization of a query executing in a distributed database according to an implementation. At a high level, the illustrated EDCS 100 includes or is made up of one or more communicably coupled computers (refer to FIG. 5) that communicate across a network 130 (note that although only one network 130 connections has been labeled in FIG. 1, one or more of the other indicated connections between components (e.g., server 1-server 6 (102a-n), visualization server 120, and client 140) can also be considered part of network 130). In some implementations, the EDCS 100 or portions of the EDCS 100 can operate within a cloud-computing-based environment. The illustrated EDCS 100 includes distributed database servers 102a-n, a visualization server 120, and a client 140.

In some implementations, the EDCS 100 can be considered a distributed database where a query is being executed. In these implementations, the visualization is of the query execution and can be run on a client external to the EDCS 100, a separate cluster of computers, or even on the EDCS 100.

The distributed database servers 102a-n perform distributed database processing for the EDCS 100. Each server generates a log (e.g., illustrated are 106a associated with server 102a and 106n associated with server 102n) that is accessible by the visualization server 120. In some implementations, the visualization server 120 accesses the log on each server 102a-n (pulls the data) for visualization computations. In other implementations, the visualization server 120 receives the log data which is pushed by each server 102x to the visualization server 120. In another possible implementation, a “coordinating” server (e.g., one of servers 102a-n) pulls/receives log data from each server 102x and creates a combined log that is provided to the visualization server 120. A mixture of these two methods is also possible in some instances. The visualization server 120 includes at least one or more visualization engines and data storage for visualization data (neither illustrated). The one or more visualization engines are used to at least process the log data from servers 102a-n and generate appropriate visualizations of query execution data associated with servers 102a-n. In some implementations, the generated visualizations/associated data are stored in a data storage associated with the visualization server (internal and/or external to the visualization server 120).

The log 106x data is accessed for data used to display, for example, data traffic between servers, processing activity on a particular server 102x, and other data. In some implementations, either a particular server 102x or the visualization server 120 can be configured to filter particular data written to, received, read, etc. from a log 106x. In typical implementations, data is accessed from logs in order to avoid computationally costly database activity monitoring.

Client 140 is used to retrieve/receive (depending upon whether the client pulls off is pushed the appropriate visualization data from the visualization server 120) and view visualization data from the visualization server 120. Note that in some implementations, one or more of the servers 102a-n and/or client 140 can perform some of all of the functionality of visualization server 140 (e.g., a server 102x can be selected to also act as the visualization server 140—perhaps a server with enhanced processing capability so that the visualization functions will not impact database processing as part of the EDCS 100).

The described illustration is only one possible implementation of the described subject matter and is not intended to limit the disclosure to the single described implementation. Those of ordinary skill will appreciate the fact that the described components can be connected, separated, and/or combined, and used in alternative ways consistent with this disclosure.

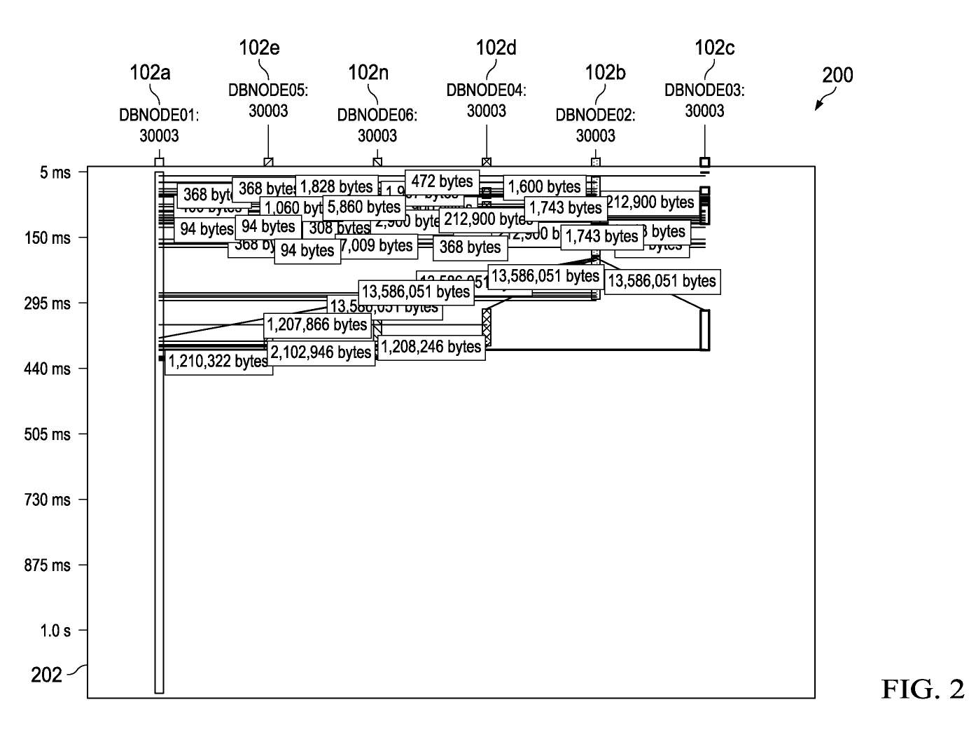

FIG. 2 is an example illustration 200 of a typical two-dimensional data chart displaying query execution data associated with the EDCS according to an implementation. Time is indicated on the Y-axis 202. The X-axis is used to indicate data traffic (amount of data) between each individual server (e.g., 102a-n) (e.g., at 204, data traffic occurs between server 102c and 102a (472 bytes is transferred between them). Note that in some implementations, there is no proportionality on the X-axis. In other words, a displayed arrow from server A to server B will look the same regardless of whether 1 byte or 1 GB is being transferred between the servers. As it can be seen, with increased data activity in a compressed time frame, the data chart becomes cluttered and difficult to read.

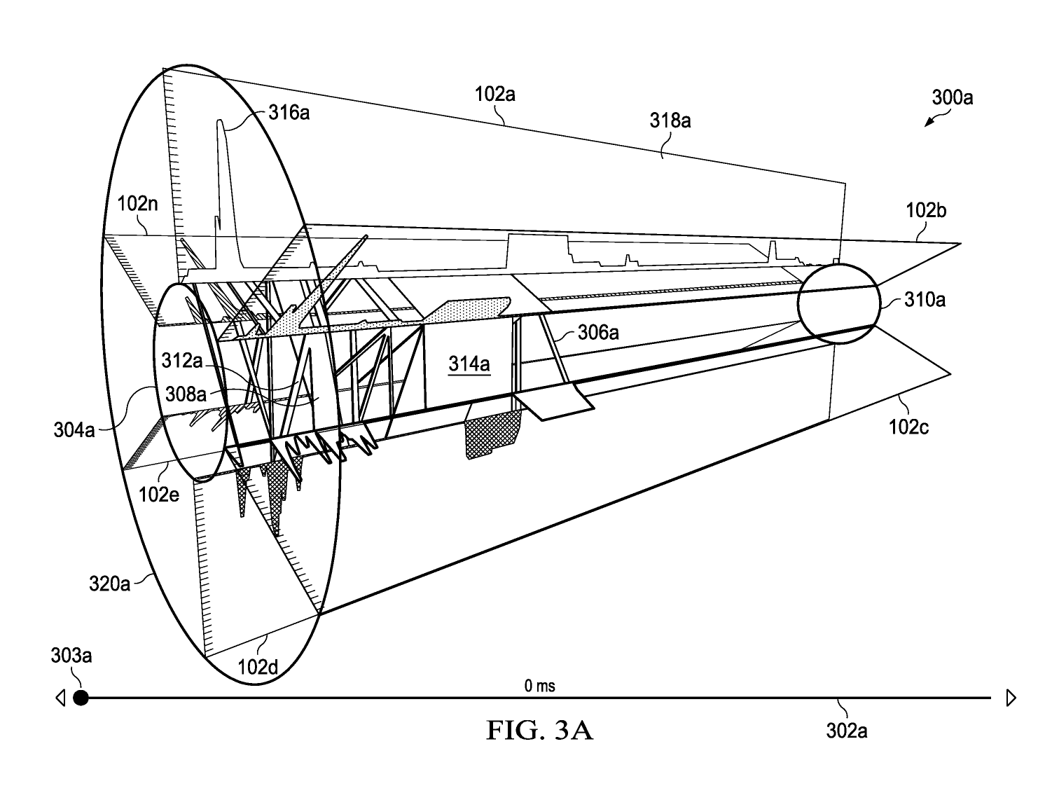

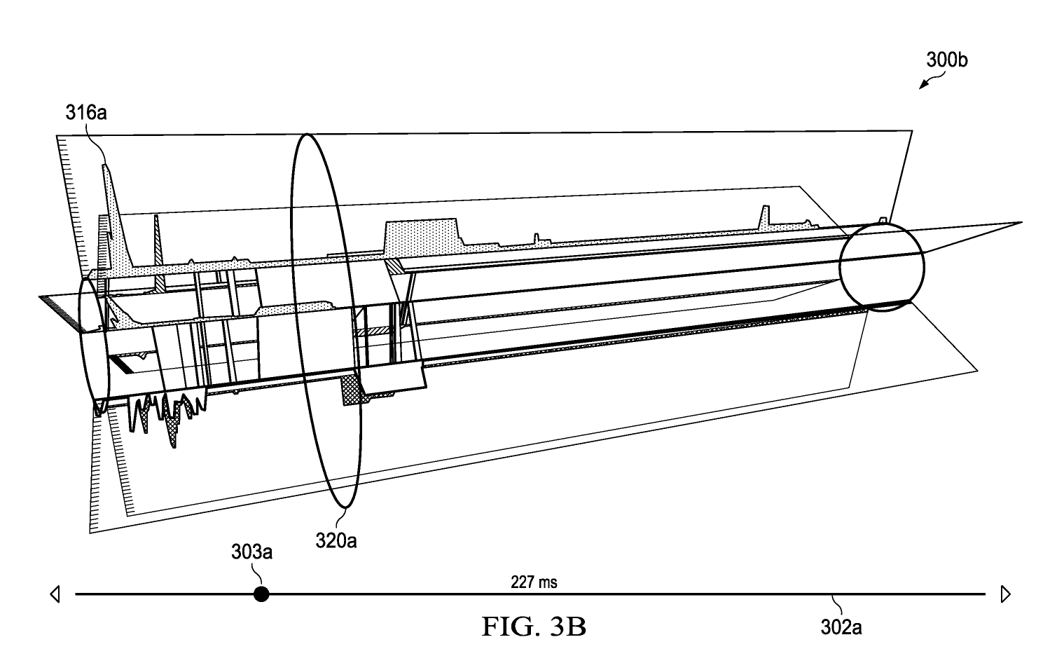

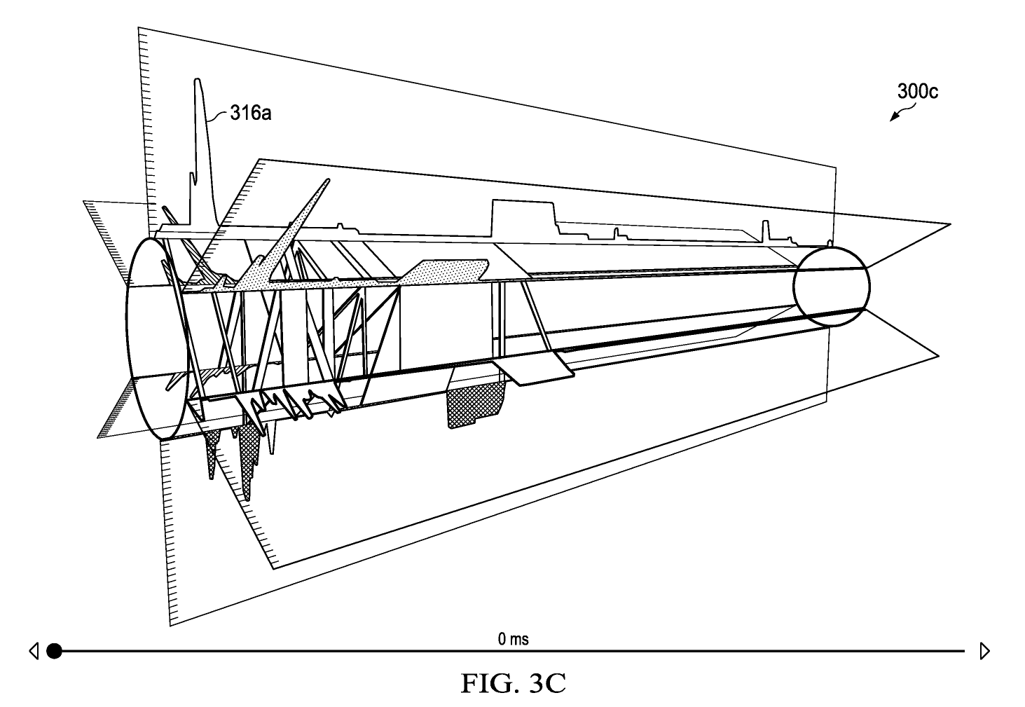

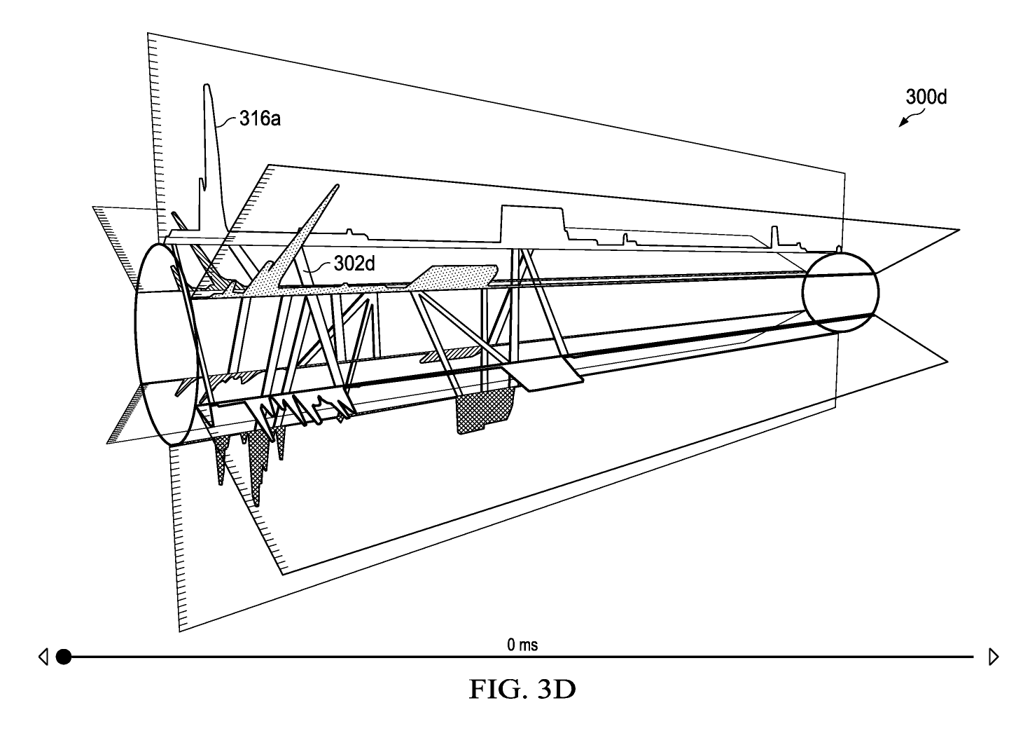

FIG. 3A is an example illustration 300a of a multi-dimensional visualization of query execution in a distributed database of the EDCS 100 according to an implementation. Time is shown on axis 302a (note that slider 303a indicates time is at 0 ms). Circle 304a is used as a basic form to display database servers (e.g., servers 102a-n) as part of a distributed database system as equally spaced points (e.g., the illustrated distributed database system has six servers as in FIGS. 1-2. For example, the six servers 102a-n could be placed on the circle as illustrated.

Lines are used to represent data traffic between the points (servers) on the circle. For example, 306a indicates traffic between severs 102b and 102c at a particular time(s). As illustrated at 308a, a larger amount of data traffic occurs between the servers at the time corresponding to 308a (generally corresponding to the times and traffic illustrated on FIG. 2) in comparison to the time indicated by 306a. As can be seen, data traffic between servers is drawn at an appropriate place within the cylinder connecting a line to another line. As described above, multiple data traffic indication options are possible with respect to drawing lines—such as: (i) drawing a perpendicular line from a server A to a server B (i.e., a start time of a transfer to start time of transfer), (ii) drawing a diagonal arrow from server A to server B (i.e., start time of transfer to end time of transfer) or (iii) drawing an area spanning server A to server B and start time of transfer to end time of the transfer (such as 314a). Note also that for indicated traffic 306a and 312a, the illustrated traffic spans a small amount of time and is shown from the 12 O'clock to 4 O'clock server, respectively). Note that the arrow/gradient on the arrow/area can indicate a data traffic flow direction (e.g., server A→server B vs. server B→server A).

As shown, the third dimension is used to represent time with respect to each point. As a result, the circle 304a becomes a cylinder. A line is formed by time progressing with respect to each point. The line typically extending perpendicular to the circle. One end of the cylinder (e.g., the left 304a) represents the start (time=0) of a query; the other end of the cylinder 310a represents the successful completion of the query.

The outer side of the cylinder is extended outwardly with information about the activity (e.g., the number of operations that are active at any given time during the query execution, the CPU utilization, the number of rows currently being processed, and/or the like) on a particular server (e.g., this can be represented using a regular line chart positioned with its base as line representing the server through time). For instance, looking along the axis of the “cylinder”, the result would resemble a sun with round body and sun “rays” (server activity) extending outwardly. Looking from the side, the activity of a particular node(s) is shown. For example, 316a indicates a relative amount of activity with respect to a database query for server 102a illustrated against a “vane”-type data structure 318a (e.g., with grid lines/tick marks/lines) allowing a proportionality determination of quantity/amount with respect to data activity as well as to provide greater visual clarity between activity related to specific servers.

In this example, the “cylinder” can be rotated and rolled in three dimensions to allow any area of the visualization to be closely examined and studied. In some implementations, filters can be provided by the visualization engine, client, etc. to allow for particular data to be filtered/removed from the visualization to help de-clutter the visualization or to focus on one or more particular servers. Available attributes of the visualization (e.g., color, patterns, background, zoom, orientation, etc.) can also be modified to help clarify the visualization.

As will be understood by those of ordinary skill in the art, the use of a circle to space database servers, displayed colors or patterns/hashing, etc. can be altered within the scope of this disclosure and the particular implementation is not meant to be limiting in its application. For example, a square, triangle, or other shape could be used other than a circle; different patterns/hashing could be used other than color to distinguish between servers, data activity, etc.; an illustrated data snapshot tool 320a (refer to FIG. 3B) can be a shape other than a disk; and the like.

FIG. 3B is an example illustration 300b of a multi-dimensional visualization of query execution in a distributed database of the EDCS with an active data snapshot tool 320a according to an implementation. Example illustration 300b can be assumed to be displaying a data structure of all intents and purposes similar to that of FIG. 3A. Data snapshot tool 320a is illustrated as a disk. In this implementation, the movement of the slider 303a (e.g., to time=277 ms), moves the data snapshot tool 320a indicator (e.g., a disk) along the cylinder of the visualization and creates a cross-sectional slice of the distributed database visualized activity. In some implementations, at a particular data point, data pertaining to the servers, data activity, etc. could be dynamically updated and displayed on a display with the visualization (not currently illustrated). A user can move the data snapshot tool 320a to particular times in order to analyze the state of distributed database system at a particular time. In some implementations, this data can be used for other processing (e.g. to act as a point at which to request more low-level data for further/deeper analysis), be saved, transmitted, etc.

Note that, in some implementations, it is possible to extend the data snapshot tool 320a to allow zooming/drilling into details (e.g. the first part of the query where many data transfers are illustrated—e.g., 308a and 312a). For this, a user can select a start time (e.g., of a time interval of interest) and then extrude the disk along the X axis (thereby the disk becomes a cylinder) towards an end time of the time interval of interest). Once the user finishes the selection, the visualization can be made to only show a visualization for the selected time interval. This would allow for expanding a time dimension and a closer look at what happens in a particular time range (or at a particular time). Note, although data snapshot tool 320a is illustrated in FIG. 3A (not labeled), in some implementations, the data snapshot tool 320a is not visible unless activated (refer to FIG. 3C—FIG. 3C is an example illustration 300c of the multi-dimensional visualization of FIG. 3A without an active data snapshot tool according to an implementation). FIG. 3D is an example illustration 300d of the multi-dimensional visualization of FIG. 3C with alternative data traffic indication lines 302d (see descriptions above) according to an implementation.

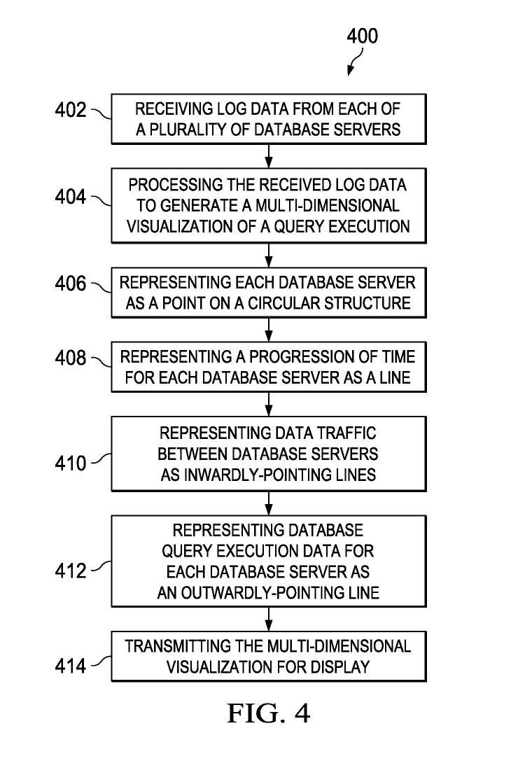

FIG. 4 is a flow chart of a method 400 providing multi-dimensional visualization of a query executing in a distributed database according to an implementation. For clarity of presentation, the description that follows generally describes method 400 in the context of FIGS. 1-2 and 3A-3B. However, it will be understood that method 400 may be performed, for example, by any other suitable system, environment, software, and hardware, or a combination of systems, environments, software, and hardware as appropriate. In some implementations, various steps of method 400 can be run in parallel, in combination, in loops, and/or in any order.

At 402, log data is received from each of a plurality of database servers forming a distributed database system executing a database query. From 402, method 400 proceeds to 404.

At 404, the received log data is processed to generate a multi-dimensional visualization of the database query execution in the distributed database. In typical implementations, the processing encompasses 406-412 below. From 404, method 400 proceeds to 406.

At 406, each of the plurality of database servers is represented as a point on a circular structure, each point equidistant from each other on the circular structure. From 406, method 400 proceeds to 408.

At 408, a progression of time is represented with respect to each point as a line corresponding to each database server, wherein the line projects perpendicularly from the circular structure and connects to another circular structure parallel to the circular structure, and wherein time is the same at a particular corresponding point on each line. From 408, method 400 proceeds to 410.

At 410, data traffic between database servers is represented as inwardly-pointing data traffic lines connecting the lines corresponding to the database servers. Data traffic between servers (symbolized by the lines) is drawn at an appropriate place within the cylinder connecting a line to another line. Note that multiple options are available such as: (i) drawing a perpendicular arrow from a server A to server B (i.e., a start time of a transfer to start time of transfer), (ii) drawing a diagonal arrow from server A to server B (i.e., start time of transfer to end time of transfer) or (iii) drawing an area spanning server A to server B and start time of transfer to end time of the transfer. From 410, method 400 proceeds to 412.

At 412, information about database query execution is represented with respect to each database server in a outwardly direction from the lines representing the database servers. Here the outer side of the cylinder is extended outwardly with information about the activity (e.g., the number of operations that are active at any given time during the query execution) on a particular server (e.g., this can be represented using a regular line chart positioned with its base as line representing the server through time). For instance, looking along the axis of the “cylinder”, the result would resemble a sun with round body and sun “rays” (server activity) extending outwardly from it. Looking from the side, the activity of a particular node(s) is shown. From 412, method 400 proceeds to 414.

At 414, the multi-dimensional visualization is transmitted to a client device for display. From 414, method 400 stops.

FIG. 5 is a block diagram 500 of an exemplary computer 502 used in the EDCS 100 according to an implementation. The illustrated computer 502 is intended to encompass any computing device such as a server, desktop computer, laptop/notebook computer, wireless data port, smart phone, personal data assistant (PDA), tablet computing device, one or more processors within these devices, or any other suitable processing device, including both physical and/or virtual instances of the computing device. Additionally, the computer 502 may comprise a computer that includes an input device, such as a keypad, keyboard, touch screen, or other device that can accept user information, and an output device that conveys information associated with the operation of the computer 502, including digital data, visual and/or audio information, or a GUI.

The computer 502 can serve as a client (e.g., client 102), network component, a server, a database or other persistency, and/or any other component of the EDCS 100. The illustrated computer 502 is communicably coupled with a network 530 (e.g., the network 130 of FIG. 1). In some implementations, one or more components of the computer 502 may be configured to operate within a cloud-computing-based environment.

At a high level, the computer 502 is an electronic computing device operable to receive, transmit, process, store, or manage data and information associated with the EDCS 100. According to some implementations, the computer 502 may also include or be communicably coupled with an application server, e-mail server, web server, caching server, streaming data server, business intelligence (BI) server, and/or other server.

The computer 502 can receive requests over network 530 from a client application (e.g., executing on another computer 502) and responding to the received requests by processing the said requests in an appropriate software application. In addition, requests may also be sent to the computer 502 from internal users (e.g., from a command console or by other appropriate access method), external or third-parties, other automated applications, as well as any other appropriate entities, individuals, systems, or computers.

Each of the components of the computer 502 can communicate using a system bus 503. In some implementations, any and/or all the components of the computer 502, both hardware and/or software, may interface with each other and/or the interface 504 over the system bus 503 using an application programming interface (API) 512 and/or a service layer 513. The API 512 may include specifications for routines, data structures, and object classes. The API 512 may be either computer-language independent or dependent and refer to a complete interface, a single function, or even a set of APIs. The service layer 513 provides software services to the computer 502 and/or the EDCS 100. The functionality of the computer 502 may be accessible for all service consumers using this service layer. Software services, such as those provided by the service layer 513, provide reusable, defined business functionalities through a defined interface. For example, the interface may be software written in JAVA, C++, or other suitable language providing data in extensible markup language (XML) format or other suitable format. While illustrated as an integrated component of the computer 502, alternative implementations may illustrate the API 512 and/or the service layer 513 as stand-alone components in relation to other components of the computer 502 and/or EDCS 100. Moreover, any or all parts of the API 512 and/or the service layer 513 may be implemented as child or sub-modules of another software module, enterprise application, or hardware module without departing from the scope of this disclosure.

The computer 502 includes an interface 504. Although illustrated as a single interface 504 in FIG. 5, two or more interfaces 504 may be used according to particular needs, desires, or particular implementations of the computer 502 and/or EDCS 100. The interface 504 is used by the computer 502 for communicating with other systems in a distributed environment—including within the EDCS 100—connected to the network 530 (whether illustrated or not). Generally, the interface 504 comprises logic encoded in software and/or hardware in a suitable combination and operable to communicate with the network 530. More specifically, the interface 504 may comprise software supporting one or more communication protocols associated with communications such that the network 530 or interface's hardware is operable to communicate physical signals within and outside of the illustrated EDCS 100.

The computer 502 includes a processor 505. Although illustrated as a single processor 505 in FIG. 5, two or more processors may be used according to particular needs, desires, or particular implementations of the computer 502 and/or the EDCS 100. Generally, the processor 505 executes instructions and manipulates data to perform the operations of the computer 502. Specifically, the processor 505 executes the functionality providing multi-dimensional visualization of a query executing in a distributed database according to an implementation.

The computer 502 also includes a memory 506 that holds data for the computer 502 and/or other components of the EDCS 100. Although illustrated as a single memory 506 in FIG. 5, two or more memories may be used according to particular needs, desires, or particular implementations of the computer 502 and/or the EDCS 100. While memory 506 is illustrated as an integral component of the computer 502, in alternative implementations, memory 506 can be external to the computer 502 and/or the EDCS 100.

The application 507 is an algorithmic software engine providing functionality according to particular needs, desires, or particular implementations of the computer 502 and/or the EDCS 100, particularly with respect to functionality required providing multi-dimensional visualization of a query executing in a distributed database according to an implementation. For example, application 507 can serve as one or more components/applications described with respect to FIGS. 1-2, 3A-3B, and 4 (e.g., a visualization engine as part of the visualization server 120, a logging engine associated with server 102a-n, a client browser application user to display the visualization to a user of client 140, etc.). Further, although illustrated as a single application 507, the application 507 may be implemented as multiple applications 507 on the computer 502. In addition, although illustrated as integral to the computer 502, in alternative implementations, the application 507 can be external to the computer 502 and/or the EDCS 100.

There may be any number of computers 502 associated with, or external to, the EDCS 100 and communicating over network 530. Further, the term “client,” “user,” and other appropriate terminology may be used interchangeably as appropriate without departing from the scope of this disclosure. Moreover, this disclosure contemplates that many users may use one computer 502, or that one user may use multiple computers 502.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus,” “computer,” or “electronic computer device” (or equivalent as understood by one of ordinary skill in the art) refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
receiving log data from each of a plurality of database servers forming a distributed database system executing a database query;
processing, by a computer, the received log data to generate a multi-dimensional visualization of the database query execution in the distributed database, wherein the multi-dimensional visualization includes:
representing each of the plurality of database servers as a point on a circular structure, each point equidistant from each other on the circular structure;
representing a progression of time with respect to each point as a line corresponding to each database server, wherein the line projects perpendicularly from the circular structure and connects to another circular structure parallel to the circular structure, and wherein time is the same at a particular corresponding point on each line;
representing data traffic between database servers as inwardly-pointing data traffic lines connecting the lines corresponding to the database servers; and
representing information about database query execution with respect to each database server in an outwardly direction from the lines representing the database servers; and
transmitting the multi-dimensional visualization to a client device for display.

2. The method of claim 1, wherein the circular structure represents a starting time and the another circular structure indicates a stop time.

3. The method of claim 1, wherein the inwardly-pointing data traffic lines include an arrow or gradient indicating a data traffic flow direction.

4. The method of claim 1, wherein the latest finish time for the inwardly-pointing data traffic lines determines the overall end time for the database query execution.

5. The method of claim 1, wherein the inwardly-pointing data traffic lines are drawn perpendicularly from a first database server to a second database server and indicate a start time of a transfer at both the first database server and the second database server.

6. The method of claim 1, wherein the inwardly-pointing data traffic lines are drawn diagonally from a first database server to a second database server and indicate a start time of a transfer at the first database server and a stop time of the transfer at the second database server.

7. The method of claim 1, wherein the inwardly-pointing data traffic lines are drawn to represent an area spanning from a first database server to a second database server that indicates a start time to an end time of a transfer, respectively.

8. A non-transitory, computer-readable medium storing computer-readable instructions, the instructions executable by a computer and configured to:
receive log data from each of a plurality of database servers forming a distributed database system executing a database query;
process the received log data to generate a multi-dimensional visualization of the database query execution in the distributed database, wherein the multi-dimensional visualization includes:
represent each of the plurality of database servers as a point on a circular structure, each point equidistant from each other on the circular structure;
represent a progression of time with respect to each point as a line corresponding to each database server, wherein the line projects perpendicularly from the circular structure and connects to another circular structure parallel to the circular structure, and wherein time is the same at a particular corresponding point on each line;
represent data traffic between database servers as inwardly-pointing data traffic lines connecting the lines corresponding to the database servers; and
represent information about database query execution with respect to each database server in an outwardly direction from the lines representing the database servers; and
transmit the multi-dimensional visualization to a client device for display.

9. The medium of claim 8, wherein the circular structure represents a starting time and the another circular structure indicates a stop time.

10. The medium of claim 8, wherein the inwardly-pointing data traffic lines include an arrow or gradient indicating a data traffic flow direction.

11. The medium of claim 8, wherein the latest finish time for the inwardly-pointing data traffic lines determines the overall end time for the database query execution.

12. The medium of claim 8, wherein the inwardly-pointing data traffic lines are drawn perpendicularly from a first database server to a second database server and indicate a start time of a transfer at both the first database server and the second database server.

13. The medium of claim 8, wherein the inwardly-pointing data traffic lines are drawn diagonally from a first database server to a second database server and indicate a start time of a transfer at the first database server and a stop time of the transfer at the second database server.

14. The medium of claim 8, wherein the inwardly-pointing data traffic lines are drawn to represent an area spanning from a first database server to a second database server that indicates a start time to an end time of a transfer, respectively.

15. A system, comprising:
a memory;
at least one hardware processor interoperably coupled with the memory and configured to:
receive log data from each of a plurality of database servers forming a distributed database system executing a database query;
process the received log data to generate a multi-dimensional visualization of the database query execution in the distributed database, wherein the multi-dimensional visualization includes:
represent each of the plurality of database servers as a point on a circular structure, each point equidistant from each other on the circular structure;
represent a progression of time with respect to each point as a line corresponding to each database server, wherein the line projects perpendicularly from the circular structure and connects to another circular structure parallel to the circular structure, and wherein time is the same at a particular corresponding point on each line;
represent data traffic between database servers as inwardly-pointing data traffic lines connecting the lines corresponding to the database servers; and
represent information about database query execution with respect to each database server in an outwardly direction from the lines representing the database servers; and
transmit the multi-dimensional visualization to a client device for display.

16. The system of claim 15, wherein the circular structure represents a starting time and the another circular structure indicates a stop time.

17. The system of claim 15, wherein:
the inwardly-pointing data traffic lines include an arrow or gradient indicating a data traffic flow direction; and
the latest finish time for the inwardly-pointing data traffic lines determines the overall end time for the database query execution.

18. The system of claim 15, wherein the inwardly-pointing data traffic lines are drawn perpendicularly from a first database server to a second database server and indicate a start time of a transfer at both the first database server and the second database server.

19. The system of claim 15, wherein the inwardly-pointing data traffic lines are drawn diagonally from a first database server to a second database server and indicate a start time of a transfer at the first database server and a stop time of the transfer at the second database server.

20. The system of claim 15, wherein the inwardly-pointing data traffic lines are drawn to represent an area spanning from a first database server to a second database server that indicates a start time to an end time of a transfer, respectively.
